(19) United States
(12) Patent Application Publication
(10) Pub. No.: US 2011/0314065 A1
(43) Pub. Date: Dec. 22, 2011

(54) SYSTEM, METHOD AND COMPUTER PROGRAM FOR SHARING DATA AMONG A PLURALITY OF USERS

(76) Inventors: Matthew Cox, Chestermere (CA); Sarath Samarasekera, Calgary (CA); Michael Barrette, Calgary (CA); Paul McCluskey, Calgary (CA)

(21) Appl. No.: 12/820,728

(22) Filed: Jun. 22, 2010

(51) Int. Cl. G06F 15/16; G06F 17/30

(52) U.S. Cl. 707/803; 709/204; 707/E17.005

(57) ABSTRACT

The present invention provides a system, method and computer program for sharing data among a plurality of users. It enables businesses to form business partnerships with one or more other businesses by accessing data profiles, such as business data profiles, owned or administered by the other businesses. The business data profiles used by each business partner may be modified, and the owner of the business data profile may have the ability to selectively accept the modifications, so as to modify the original business data profiles. The present invention enables instantaneous collaborative data transactions between businesses. The present invention also provides a social network for enabling businesses to discover, share, and use business data profiles created by other businesses.

### FIELD OF THE INVENTION

The present invention relates generally to data sharing to facilitate e-commerce. The present invention relates more particularly to data sharing and modification to collect an accessible network of businesses that can create, view, and modify business data profiles.

### BACKGROUND

The Internet has created an environment where the creation of information is growing more rapidly than at any time in human history. Information on other businesses' inventory, inventory levels, available credit, and product marketing strategies is highly valuable in the competitive modern marketplace. This information can enable a business to more strategically increase its own business, as well as form strategically advantageous business partnerships.

The identification and creation of effective business partnerships is a critical concern for retailers and service providers. Partnerships allow for the efficient exchange of business resources, credit, goodwill, inventory information and marketing techniques to facilitate the sale of products and services. While the advantages of such partnerships are self-evident, the cost to retailers of researching potential partners and engaging in these transactions can be prohibitively high.

Current Internet resources provide retailers with greater access to this business information. Nevertheless, the cost of developing and maintaining a business web site, and the cost of finding other business websites providing relevant business information is extremely high. In addition, many retailers do not wish to publicly disclose financial records and inventory data.

Several solutions have been presented for facilitating access to business data to create effective business partnerships.

United States Patent Publication No. 20080172344 to Eager et al. teaches a social network for business-to-business interaction using an e-commerce platform and system that consolidates a tiered vertical market space by connecting multiple vendors to a target audience or consumer class through an affiliate network. The purpose of such a social network is to provide consumers with centralized access to find related businesses and affiliates, however Eager et al. does not teach any means by which to leverage the business information to form effective business partnerships within the network between the vendors involved.

U.S. Pat. No. 7,574,383 to Parasnis et al. teaches a method for distributed inventory management that includes receiving information regarding a number of participants in a value chain and information regarding one or more items relevant in the value chain. The method also includes modeling relationships between two or more of the participants based on the received information and modeling the one or more items based on the received information. Furthermore, the method includes receiving inventory data from the participants relating to the one or more items, processing the inventory data based on the models of the relationships and the items to generate inventory information related to one or more of the participants, and communicating the generated inventory information to one or more of the participants. The inventory information at least partially includes information regarding inventory data of participants other than those participants to which the inventory information is communicated. Parasnis et al. presupposes a value chain and, therefore, does not contemplate and does not teach any technique by which to discover other businesses to enable a business to form strategic business partnerships.

United States Patent Publication No. 20080249900 to Von Helmolt et al. teaches a computer-implemented method and system for maintaining a plurality of dealer inventories in a supply chain management system comprising a plurality of dealer inventory data objects representing dealer inventories, a plurality of interfaces for accessing the dealer inventory data objects and a plurality of participants within the supply chain management system, wherein the dealer inventory data objects are stored with the supply chain management system; the dealer inventory data objects located with the supply chain management system of a second participant are owned by a first participant; the participants are accessing the dealer inventory data objects, wherein the first and the second participant having read and write permissions and the further participants having read permissions; and the interfaces are adapted to support online collaboration between the participants. Von Helmolt et al., like Parasnis et al., presupposes a supply chain and, therefore, does not contemplate and does not teach any technique by which to discover other businesses to enable a business to form strategic business partnerships.

United States Patent Publication No. 20080162297 to Hershkovitz et al. teaches methods and system for facilitating relationships in an e-commerce marketplace. For example, in one embodiment, there is provided a computerized method for providing virtual consignment in an e-commerce system, including receiving a request to establish a virtual consignment for an item, transmitting an offer price from a first party to the consignment and a second party to the consignment, determining if the offer price is acceptable to the second party, and automatically adding the item to an e-commerce site in if the offer price is acceptable. Hershkovitz et al. also describes methods of forming business partnerships based on sales information and statistical analyses. However, Hershkovitz does not teach any means by which to empower a business to explore other businesses' business information to independently determine whether to create a business partnership.

In addition to creating business partnerships, businesses find themselves more and more in need of relevant data, including consumer information. The value of this data has increased significantly in the last decade. Data including information on consumer habits and preferences, product success and marketing success is of critical importance to these businesses. Some solutions to gathering data efficiently have been proposed, most notably, aggregated and shared data, and collaborative data. In the aggregated and shared data model, data that is owned by one party is lost if that party leaves the aggregation model. In the collaborative data model, data is owned by the collective, meaning that none of the contributors can exclusively monetize the data. There has not yet been a practical solution to enable business partners to leverage each other's business data so as to individually benefit from the data in a meaningful way.

The prior art has not been able to provide an end-to-end solution for enabling businesses to discover other businesses for the purpose of forming business partnerships, nor has it provided using these partnerships to more effectively and efficiently gather data. Therefore, there is a need for a means by which to enable businesses to discover other businesses for the purpose of forming business partnerships and use these partnerships to more effectively and efficiently gather data.

### SUMMARY

The present invention provides a computer implemented method of sharing data among a plurality of users, the method comprising: (a) enabling a first user to create one or more data profiles, each data profile comprising one or more data elements; (b) sharing one or more of the data profiles with a second user; (c) enabling the second user to generate, or facilitate the generation of, by means of one or more computer processors, one or more additional data elements corresponding to a selected data profile; and (d) enabling the first user to selectively modify the selected data profile by adding the additional data element to the selected data profile.

The present invention also provides a system for sharing data among a plurality of users, the system comprising: (a) a data profile database defined by one or more linked databases; (b) a server computer linked to the data profile database, the server computer operable to: (i) enable a first user to create one or more first data profiles for storing on the data profile database, each data profile comprising one or more data elements; (ii) share the one or more first data profiles with a second user; (iii) enable the second user to generate, or facilitate the generation of, one or more additional data elements corresponding to a selected data profile; and (iv) enable the first user to selectively modify the selected data profile by adding the additional data element to the selected data profile.

The present invention further provides a computer program product for sharing data among a plurality of users, the computer program product comprising computer instructions which when made available to a server computer configure the server computer to provide a shared data utility, the shared data utility operable to: (a) enable a first user to create one or more data profiles, each data profile comprising one or more data elements; (b) share one or more of the data profiles with a second user; (c) enable the second user to generate, or facilitate the generation of, by means of one or more computer processors, one or more additional data elements corresponding to a selected data profile; and (d) enable the first user to selectively modify the selected data profile by adding the additional data element to the selected data profile.

The present invention still further provides a computer network implemented method of sharing data among a plurality of users in a social network, the method comprising: (a) providing, or facilitating providing, by means of one or more computer processors, a social network having a plurality of users as members, one of the plurality of users being a prospective user and the remaining users being offering users; (b) providing access to a plurality of data profiles to the prospective user by means of the social network, each data profile associated with an offering user, each data profile comprising one or more data elements; (c) enabling the prospective user to select, by means of the social network, one or more of the data profiles; (d) enabling the prospective user to publish at least one of the data profiles on a website; (e) enabling the prospective user to generate, or facilitate the generation of, an additional data element corresponding to the published data profile; and (f) enabling the offering user associated with the published user data to selectively modify the published data profile by adding the additional data element to the published data profile.

The present invention yet further provides a system for sharing data among a plurality of users in a social network, the system comprising: (a) a data profile database defined by one or more linked databases; (b) a server computer linked to the data profile database, the server computer providing a shared data utility operable to: (i) provide a social network having a plurality of users as members, one of the plurality of users being a prospective user and the remaining users being offering users; (ii) provide access to a plurality of data profiles to the prospective user by means of the social network, each data profile associated with an offering user, each data profile comprising one or more data elements; (iii) enable the prospective user to select, by means of the social network, one or more of the data profiles; (iv) enable the prospective user to publish at least one of the data profiles on a website; (v) enable the prospective user to generate, or facilitate the generation of, an additional data element corresponding to the published data profile; and (vi) enable the offering user associated with the published user data to selectively modify the published data profile by adding the additional data element to the published data profile.

The present invention additionally provides a computer program product for sharing data among a plurality of users in a social network, the computer program product comprising computer instructions which when made available to a server computer configure the server computer to provide a shared data utility, the shared data utility operable to: (a) provide a social network having a plurality of users as members, one of the plurality of users being a prospective user and the remaining users being offering users; (b) provide access to a plurality of data profiles to the prospective user by means of the social network, each data profile associated with an offering user, each data profile comprising one or more data elements; (c) enable the prospective user to select, by means of the social network, one or more of the data profiles; (d) enable the prospective user to publish at least one of the data profiles on a website; (e) enable the prospective user to generate, or facilitate the generation of, an additional data element corresponding to the published data profile; and (f) enable the offering user associated with the published user data to selectively modify the published data profile by adding the additional data element to the published data profile.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood and objects of the invention will become apparent when consideration is given to the following detailed description thereof. Such description makes reference to the annexed drawings wherein:

FIG. 1 illustrates a system in accordance with the present invention.

FIG. 2 illustrates a decision matrix for business data profile management.

FIG. 3 illustrates an example of a business data profile being modified by a second business.

FIG. 4 illustrates a three-tiered data structure of a business data profile.

FIG. 5 illustrates operation of a search utility of the present invention.

FIG. 6 illustrates an example of an inventory sharing application in accordance with the present invention.

FIG. 7 illustrates an example of a modification to a business data profile.

FIG. 8 illustrates an example of inventory sharing in accordance with the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice-versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

The invention will be explained in details by referring to the figures.

The present invention provides a system, method and computer program for sharing data among a plurality of users. The users could be people or businesses, in whatever legal form the business chooses. In the examples provided herein, the users are businesses, however it should be understood that any entities, in any combinations, can use the techniques provided in the present invention.

The present invention enables businesses to form business partnerships with one or more other businesses by accessing data profiles, such as business data profiles, owned or administered by the other businesses. A business is empowered to select strategic business partners and use their business partners' business data profiles for its own purposes. The business data profiles used by each business partner may be modified, and the owner of the business data profile may have the ability to selectively accept the modifications, so as to modify the original business data profiles.

The present invention enables instantaneous collaborative data transactions between businesses. It creates an environment that fosters marketplace access for large and small retailers, and enables efficient access to product information and optimal marketing strategies. The network of businesses created by the present invention gain a market advantage due to their access to consistently current and up-to-date product and business information.

The present invention also provides a social network for enabling businesses to discover, share, and use business data profiles created by other businesses. The social network can be used for enhancing marketing and for sharing inventory for completing consumer orders.

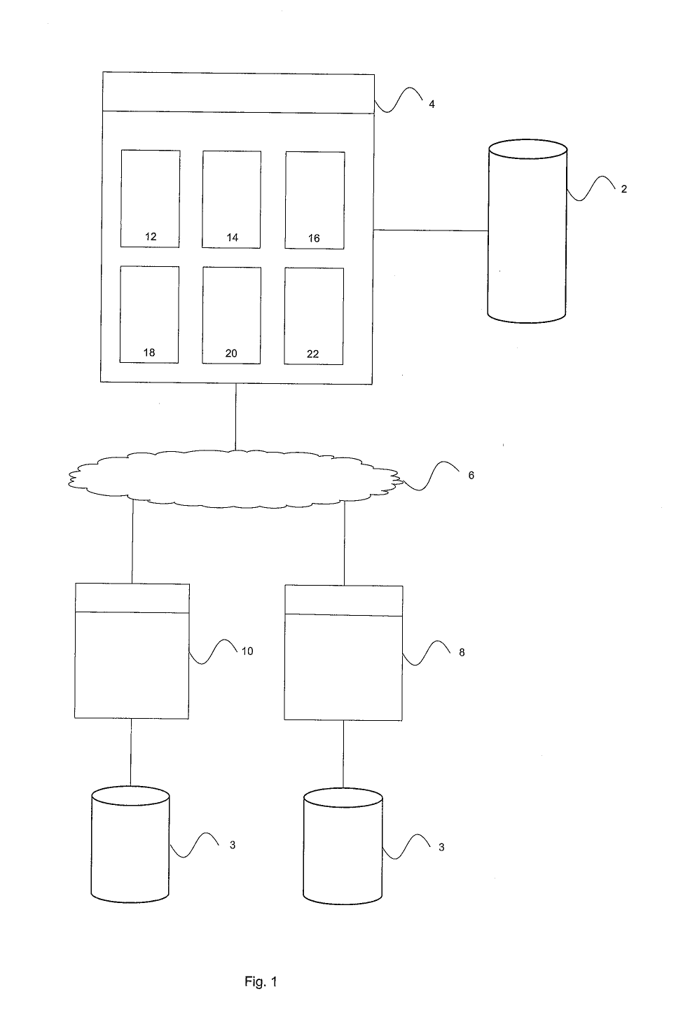

A system in accordance with the present invention is illustrated in FIG. 1. The system may include a business data profile database (2) and a server computer (4) linked to the business data profile database (2). In various implementations, the business data profile database can be centrally administered as one or more associated databases (2), or could be a distributed implementation where some or all of the businesses administer their own databases (3), or could be a combination of the two. For example, some of the businesses may choose to administer their own database while others may choose to authorize an administrator to administer a database on their behalf.

The server computer comprises one or more processors that execute, or facilitate the execution of, the business data sharing techniques of the present invention. The server computer (4) may include a profile creation utility (12), profile display utility (14), shared data utility (16) and access control utility (18). The server computer (4) may also include an order acceptance utility (20) and a content delivery utility (22) for enabling shared inventory management. The server computer (4) may be network accessible, for example by means of the Internet (6).

Each of the businesses may access the server by means of a client computer (8),(10). The client computer could be another server, a desktop or laptop computer, a tablet or slate computer, a mobile device or smartphone, etc. Mobile access to the server computer enables a business to quickly react to requests, actions, and data modifications made in accordance with the present invention. Mobile access may be provided by a mobile application or a web front-end operable with a mobile device.

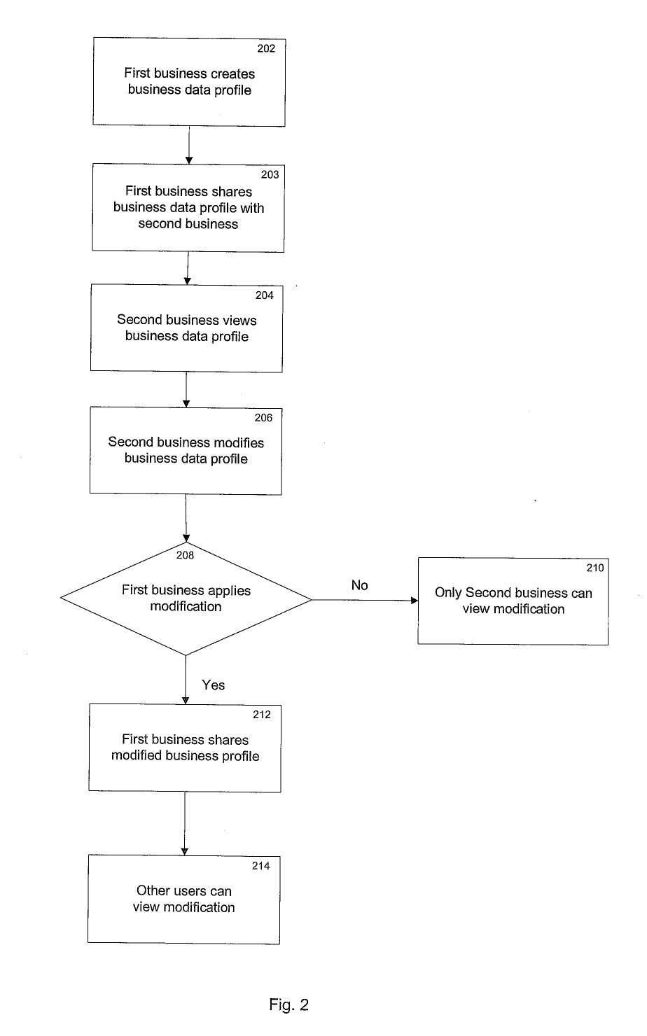

FIG. 2 illustrates an example of data sharing in accordance with the present invention. For example, in one method in accordance with the present invention, a first business creates, by means of the profile creation utility, one or more business data profiles (202) that each comprises one or more data elements. The business data profile can therefore be considered an encapsulation of the one or more data elements. The first business shares (203) at least some of the business data profiles with a second business (and optionally a third business, fourth business, etc.) by means of the access control utility. The second business can use the business data profiles, for example by viewing the business data profiles (204) by means of the profile display utility, publishing the business data profiles on an e-commerce website, etc. for its own purposes. Optionally, the second business can make modifications to the business data profile by modifying, adding or deletion it or portions thereof (206) by means of the shared data utility. The modifications to a selected business data profile are collected in additional data elements that correspond to the selected business data profile. The first business can then select, by means of the shared data utility, whether to apply the modifications and, if applied, the selected business data profile is modified by adding the additional data elements to it (208). The first business can then share, by means of the shared data utility and access control utility, the modified business data profile with other businesses (212). This will allow other users to view the modifications (214) by means of the profile display utility. Optionally, only the second business will be able to view the modifications if the first business does not accept them (210). The second business, regardless of whether the first business accepted the modifications, may still retain the information in the additional data elements, that is, the profile comprising the modifications.

The present invention therefore enables businesses (the first business, in the above example), to gather data (embodied for example as business data profiles) efficiently by leveraging business partnerships (with the second business, in the above example) and enabling their business partners to gather data on their behalf. The business that owns, creates, administers or has rights to the original business data profiles may be given the authority to selectively accept whether to apply any modifications to the business data profiles. The other businesses, meanwhile, benefit by having already gathered business data profiles at their disposal, reducing the amount of work required to prepare relevant data.

Modifications to business data profiles may be made by either modifying data elements to the original business data profile or adding data elements to the business data profile. It could also include deleting data elements within the business data profile, for example if particular data elements have lost relevance. Optionally, modified data elements may owned by the business owning the original business data profile, while added data may be owned by the business making the addition. Alternatively, added data that is accepted by the business owning the original business data profile becomes owned by that business.

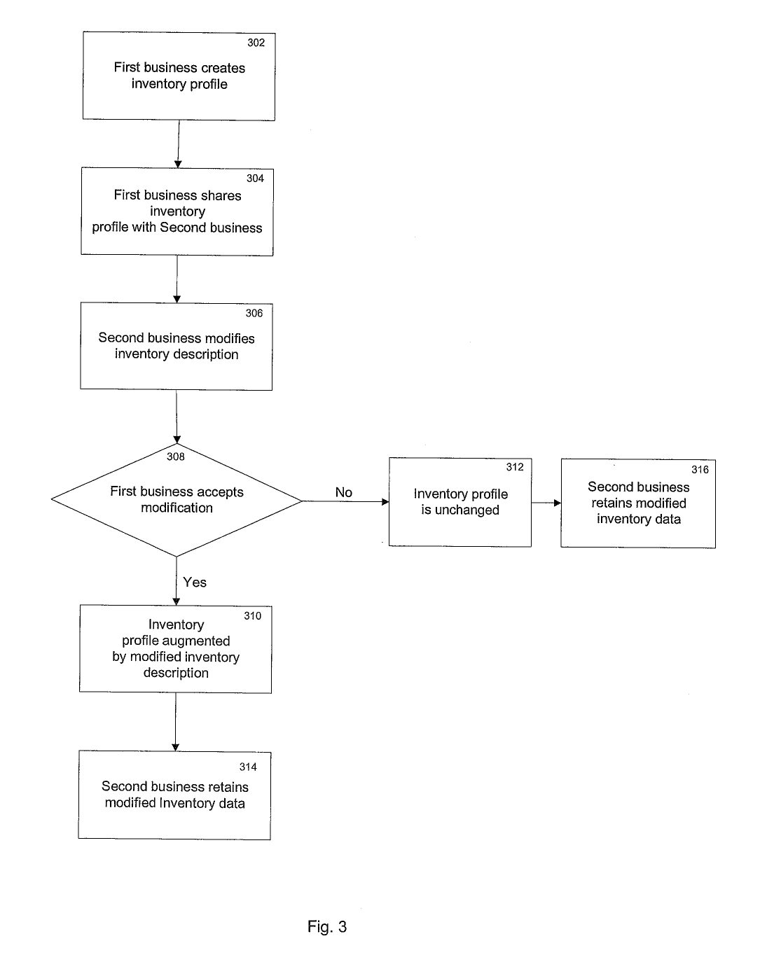

In one example of the present invention, business data profiles may correspond to inventory profiles. For example, an inventory profile can include data elements such as “inventory name”, “inventory description”, “price”, “specifications”, “consumer reviews”, etc. By enabling the first business to share the inventory profile with a second business, the first business can benefit from knowledge of the second business or its consumers, as illustrated in FIG. 3. In this example, the first business creates an inventory profile (302). The first business then chooses to share its inventory profile with a second business (304). The second business may decide to modify the “inventory description” to be more descriptive (306). The first business can then selectively accept the modifications to the original inventory profile (308). The first business benefits by having additional information in its inventory profile created at no cost to the business (310). On the other hand, it may keep its inventory profile in its unchanged state by choosing not to accept the modification (312) The second business, regardless of whether the first business accepted the modifications, may retain the modified inventory data (314, 316).

In another example, the second business may sell inventory corresponding to the inventory profile to one of its consumers. The consumer may, by means of an e-commerce site for example, provide consumer feedback that can be encapsulated in the inventory profile. The first business can then selectively accept the consumer feedback, making it available to the first business, or any other business that the first business wishes to share it with. Thus, the value of the business data profile to the first business is increased by leveraging the business partnerships of the first business. Furthermore, business partners have access to business data profiles that are being modified by any number of other businesses, enabling each business partner to benefit from the data gathering capabilities of a collective.

Business data profiles, including inventory profiles, may be used outside of e-commerce as well. For example, a second business may operate a review website or market analysis website. The second business may wish to use business data profiles for listing information related to, but not selling inventory of, the business data profiles on its website.

Another example of the use of business data profiles, including inventory profiles, in use by satirical websites. The owner of a satirical website may seek out information associated with a business data profile, but may wish to frame the information in a satirical way.

While the above example contemplates business profile data being inventory profiles, it can also include any combination of other business related information, including but not limited to inventory levels, pricing, consumer reviews, sales data, marketing techniques, financial information, intellectual property assets, tangible assets, etc. The present invention also enables the exchange of non-data business resources. Business data profiles may include information on financial assets and resources (including access to credit, for example). Businesses in need of such an asset or resource may create or maintain business partnerships based on such a need by means of the present invention. In this way, business partners can gain access to a greater marketplace and increased business and financing opportunities.

The sharing of business data profiles can also be implemented within a drop-shipping, consignment, or reselling environment. For example, the first business in the above example may be an inventory supplier while the second business may be a reseller. The inventory supplier may be the originator of inventory profiles for its inventory. The inventory supplier may share its inventory profiles with the reseller, enabling the reseller to publish data in the inventory profiles on an e-commerce website. Sales of the inventory by the reseller to a consumer can be communicated to the first business, resulting in the first business transferring the inventory to the consumer.

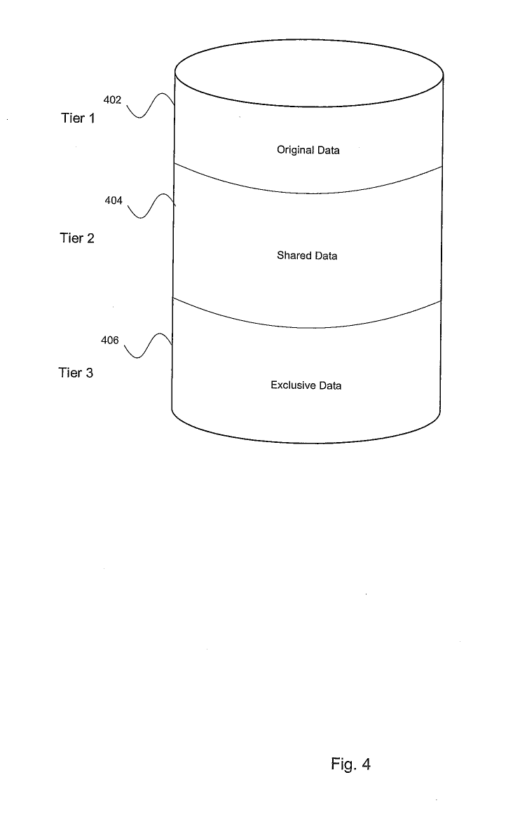

The recording of business data profiles can be implemented on a three-tier data storage platform, as shown in FIG. 4. A first tier (402) may record original data, a second tier may record shared data and a third tier may record exclusive data.

In a first tier (402), the first business can create and own a primary business data profile (PBDP). The PBDP may comprise one or more data elements populated by the first business. Any changes made to the PBDP augment the original PBDP. The PBDP may be shared with a second business. The second business may choose to use the PBDP as created, or make modifications, additions or deletions to one or more of the data elements of the PBDP.

In a second tier (404), modifications may be made by a second business (or the first business or another business) and may be recorded as additional data elements. The modifications may then be communicated to the first business, which may select whether to apply the changes or not. If the changes are applied by the first business, the additional data elements augment the corresponding original data elements and are recorded in the first tier, and ownership of the PBDP may remain with the first business. If the changes are not applied by the first business, the ownership of the original PBDP data elements may be with the first business while ownership of the additional data elements may be with the second business, and the first business may not necessarily have access to modify the additional data elements. The first business may share the entire PBDP with additional businesses, while the second business may share their select data elements with additional businesses.

In a third tier (406), the second business (or the first business or another business) may make private modifications that are not communicated back with the first business nor made accessible to other businesses. All three tiers of information are preferably recorded in a single PBDP, however it should be understood that the present invention contemplates that separate business data profiles could be used to implement a three-tier data storage platform.

The foregoing examples provide sharing of data from a first business to a second business, third business, etc. However it should be understood that the present invention is applicable to a network of businesses such that any or all of the businesses involved may by the owner or originator of a given business data profile and can choose to share its business data profiles with any of the other businesses involved, providing a multidirectional sharing of business data profiles. Furthermore, the business data profiles of the present invention need not be similar in form or format to be shared with the other businesses.

As previously mentioned, the server computer may provide: (1) a profile creation utility enabling each business to create a business data profile; (2) a profile viewing utility; (3) an access control utility; and (4) a shared business data utility enabling members of the network to use business partners' business data (by means of accessible business data profiles). Optionally a search utility may be provided. The server computer may provide access to these utility by means of a social network. In particular examples, such as where at least one of the business data profiles are inventory data, an order acceptance utility and a content delivery utility may also be provided to enable consumers to access particular data elements of the inventory data for one or more of the businesses.

A social network may be provided for enabling sharing data in accordance with the present invention. For example, the server computer may provide a social network having a plurality of businesses as members. Each of the businesses may contribute business data profiles to the social network. Each of the businesses may also seek out business data profiles of other businesses so as to create or maintain business partnerships. A business seeking out business data profiles of other businesses may be referred to as a prospective business. The other businesses may be referred to as offering businesses.

The profile creation utility may enable a business to register a business data profile with the social network, which may include providing data to populate one or more data elements in the business data profile corresponding to the particular goods, services, assets and/or resources that are the subject of the business data profile. The business data profile may be recorded to the business data profile database and an indication may be made in the business data profile database that the business data profile is owned by the business.

The business may configure the business data profile, for example by configuring security settings that define which other businesses may discover the business data profile by means of the social network, whether it is by degrees of separation (i.e. already connected through one or more other business links in the social network), geographical restrictions, line of business, credit ability, etc. The business may also delete the business data profile from the business profile database if desired.

The access control utility may enable levels of sharing of business data profiles to be established based on security settings configured by the business owning the business data profile. For example, the business may configure which of the business data profiles to make available to which business partners, potential business partners, categories of business partners or categories of potential business partners. The first business may also configure the security settings based on individual or groups of data entities within each of the business data profiles.

The profile viewing utility may enable businesses to discover potential business partners by viewing business data profiles. The profile viewing utility may provide search and/or browse functions enabling a business to view other businesses' business data profiles. By browsing/searching the social network, a business can discover business data profiles satisfying their needs for goods, services, assets and/or resources.

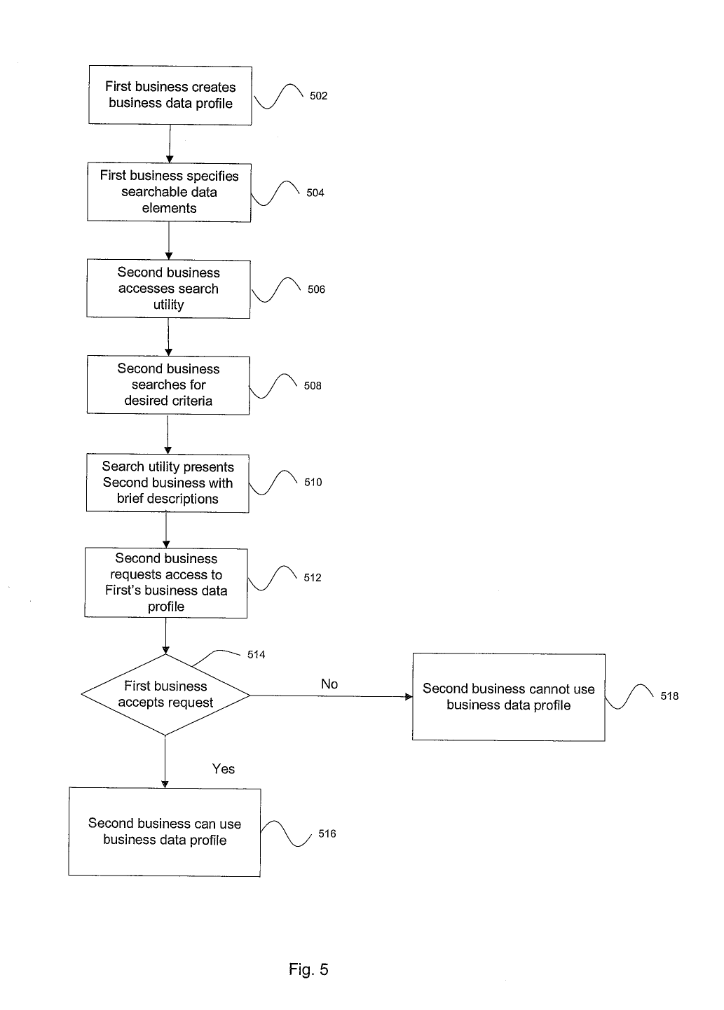

FIG. 5 illustrates an example of the search utility. The first business may create a business data profile (502) and may specify that certain data elements are searchable, such as a brief description data element (504). The second business may access the search utility (506) and search for desired criteria, such as a specific inventory item (508). The second business may be interested in potential business data profiles for many reasons, including for example, type of business, inventory availability, product pricing, inventory selection, credit availability, other assets, other resources, inventory levels, marketing strategies, etc. The search utility may present this second business with matching or near-matching brief description data elements, each corresponding to business data profiles (510). The second business may request access (512) to the business data profile of the first business, which the first business may selectively accept or reject (514). Acceptance allows the second business to use the business data profile (516). Rejection of the request may result in the second business not being able to use the business data profile (518).

The shared business data utility may enable businesses to make and maintain connections with each other by means of the social network. A business, for example, may discover a business data profile of interest and desire to access the business data profile. The business may request such access, resulting in a request to be sent to the owner of the business data profile, as recorded in the business data profile database. The owner can accept or reject the request. If the request is accepted, the requesting business may be provided with access to the business data profile.

If access to the business data profile is permitted, the requesting business may publish the business data profile on an e-commerce website. The requesting business may choose to generate additional data elements corresponding to the published business data profile before and/or after it is published. The requesting business may also choose to enable others to generate additional data elements corresponding to the published data profile after it is published.

If additional data elements are generated by the requesting business or by others through the requesting business, the additional data elements may be associated with the requesting business in the business data profile database.

If the owner of the original business data profile selects to apply the modifications to the original business data profile, then the modified business data profile may be associated with this owner in the business data profile database. Moreover, the additional data elements may be associated with the requesting business in the business data profile database. In this case, even if the owner of the original business data profile desires to delete the original business data profile from the business data profile database, the additional data elements remain as leveragable data.

Optionally, when a business gains access to a particular business data profile, the social network may publish an alert, such as in a feed and/or a “status update” as is commonly known to those skilled in the art, publicizing that the business is using the business data profile. Other businesses may be granted access and/or may subscribe to the feed so as to use the information in a feed to determine which business data profiles it wishes to use.

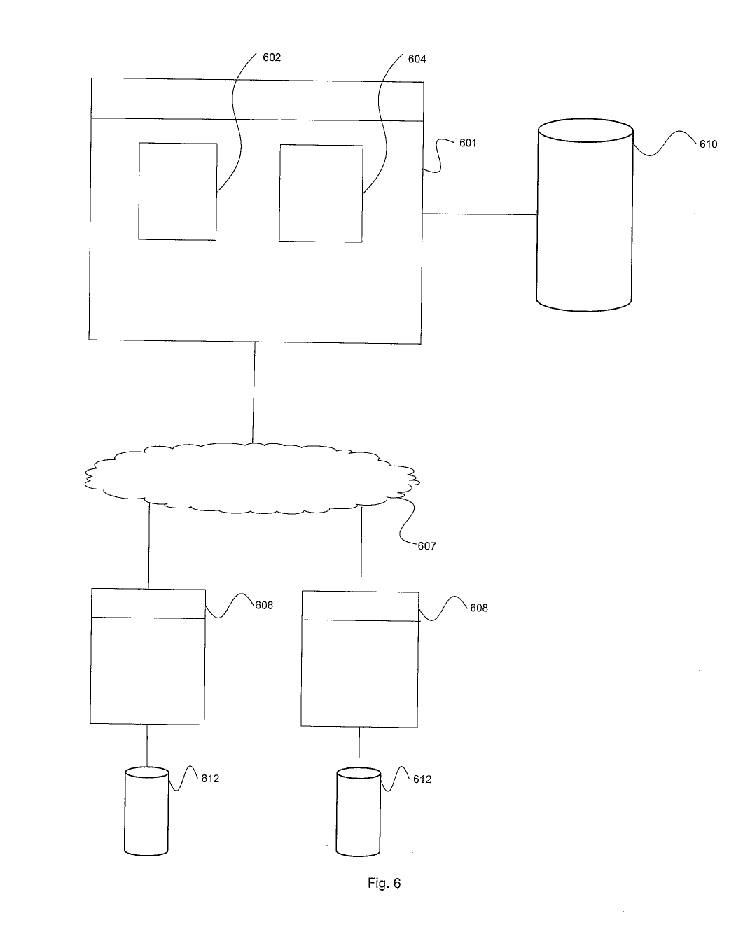

Shared inventory management may be provided by an order acceptance utility and a content delivery utility. Shared inventory management may enable consumers to access particular data elements of inventory data for one or more businesses to more efficiently transact with the businesses. Inventory data is one type of business data profile that may be provided by businesses. FIG. 6 illustrates shared inventory management. A server computer (601) may provide shared inventory management by an order acceptance utility (602) and a content delivery utility (604) for enabling shared inventory management. A business that is registered with the social network of the present invention may connect to the server by means of a client computer (606) connected to a network such as the Internet (607) provide one or more inventory data for sharing with other businesses on the social network. The business owning the inventory data and at least one business accessing the inventory data by means of another client computer (608) connected to the network may enrol or be enrolled in shared inventory management, or shared inventory management may be automatically enabled in the social network. Inventory information may be centrally administered as one or more associated databases (610), or could be a distributed implementation where some or all of the businesses administer their own databases (612), or could be a combination of the two. Shared inventory management may result in the inventory data being accessible by the content delivery utility (604). An e-commerce website, or e-commerce front-end to the social network, may be provided for enabling consumers to access inventory corresponding to inventory data by means of the content delivery utility. A consumer may purchase one or more items of inventory. The purchases may be ordered via the order acceptance utility (602), which collects purchase and shipping information from the consumer and communicates this information to the business from which inventory was purchased. If the business does not have any remaining inventory of the item, the order acceptance utility (602) determines whether any other enrolled business has inventory and, if so, communicates the purchase and shipping information to that business for completing the order. This allows businesses in the network to capitalize on the goodwill and/or available inventory levels of other merchants.

The social network may also include an e-commerce utility enabling a member business to operate an e-commerce website in accordance with the present invention. Alternately, an application programming interface (API) may be provided for enabling a business to interface an external e-commerce website with the social network of the present invention.

As previously mentioned, a client computer enabling access by a business to a social network of the present invention may be a mobile device. A mobile device may enable a business to interact with the social network on an always-accessible basis. Since business data profiles in the present invention can be modified by multiple businesses at various times, an owner or user of the business data profile may have a desire to quickly react to modifications, requests and other actions relating the business data profile. For example, if a product recall is announced, an owner of an affected inventory profile could modify the inventory profile to prevent future sales of inventory. Users of the inventory profiles would be automatically affected. In another example, a user could modify the inventory profile to prevent future sales of inventory. In this case, providing the owner of the inventory profile with mobile and immediate access to the social network of the present invention enables the owner to apply the modification, so as to enable other users of the inventory profile to benefit from the modification.

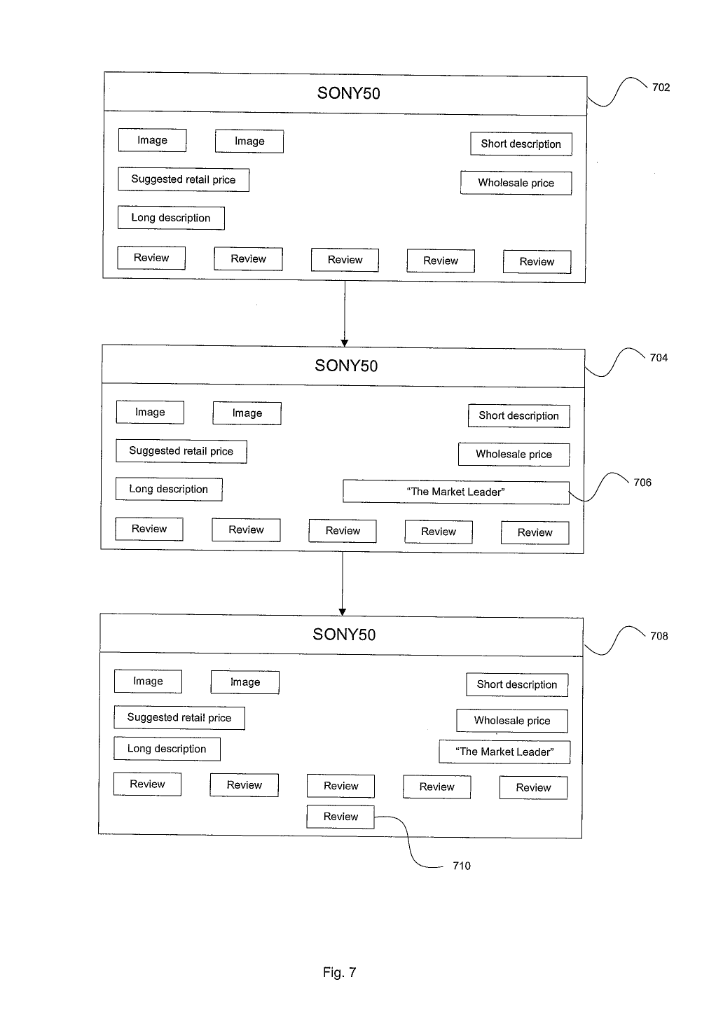

In a particular example of data sharing in accordance with the present invention, illustrated in FIG. 7, three businesses may be involved. In this example, MA is the originator of the business data profile, MB is a secondary user who has access to the business data profile and modifies it and MC is an additional user who has access to the business data profile.

MA is an electronics distributor selling Sony™ 50 inch flat screen televisions. MA registers with the social network of the present invention and creates an original business data profile with name SONY50 (702) and the following information; two product images, a short description, a long description, suggested retail price, wholesale price, and five consumer reviews. Each of these pieces of information defines a data element encapsulated in the business data profile.

MB is an electronics retailer selling televisions online MB registers with the social network of the present invention, discovers SONY50, and connects to MA. MA grants MB access to SONY50, allowing MB to resell the Sony™ 50 inch flat screen televisions. MB lists MA's Sony™ 50 inch flat screen televisions on its website for sale by publishing SONY50 (704). MB modifies the long description with “The Market Leader” tagline (706). The new long description is recorded as an additional data element to the business data profile.

MA accepts the new long description as part of the business data profile. The original business data profile is now augmented with the new long description. MA's data has now grown, as it consists of two images, one short description, two long descriptions, suggested retail price, wholesale price and five consumer reviews. MA is the owner of the business data record and MB is also an owner of the additional data element and also has access to this modified primary data record.

Furthermore, in the course of selling the Sony™ 50 inch flat screen televisions, one of MB's consumers also leaves a product review on MB's e-commerce website. MB adds the product review to the business data profile (708), which is accepted by MA. MA's data record has grown again to include an additional customer review (710). It consists of two images, one short description, two long descriptions, suggested retail price, wholesale price and six consumer reviews.

MC is another electronics retailer selling televisions online MC registers with the social network of the present invention and discovers SONY50 and connects to MA. MA grants MC access to MA's primary data records. MC publishes MA's SONY50 for sale on its e-commerce website using two images, one short description, one long description—the long description generated by MB, and six product reviews.

MA, MB, and MC have all benefited from access to greater business data provided by one another. The access controls ensure that only those businesses that the data originator wants to provide with access to their information are able to get it. This ensures that, for instance, businesses that are competing with each other are not providing one another with confidential business information. It also ensures that only businesses who are interested in the information and who can themselves provide information of value to the data originator are allowed access to the business data profile.

An additional benefit of the present invention is that large product distributors may easily and instantaneously deliver marketing materials to their retailers. A distributor could register with the social network of the present invention and create a business data profile containing the suggested retail price and two marketing images for their new product. They could then enable all of their retailers to have access to this business data profile. Those retailers could, in turn, provide effective marketing data and product feedback on the business data profile, accessible by both the product distributor and, at the originator's discretion, the other retailers as well. Should the product distributor find that a particular marketing image has been unsuccessful, they could remove the image from the business data profile and replace it with new marketing materials that would be instantaneously available to its retailers. Those retailers could immediately put these materials to use, gaining a significant market advantage on their slower competitors.

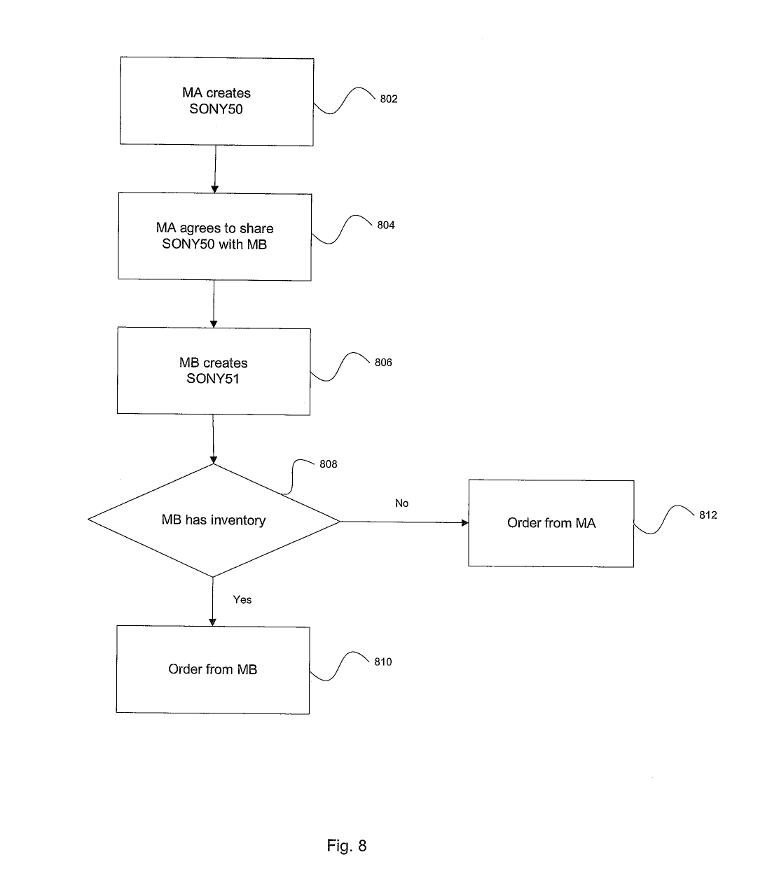

In an example shared inventory management, illustrated in FIG. 8, two businesses may be involved. In this example, MA is the originator of inventory data and MB is a secondary user who has access to the inventory data. The inventory data is made accessible by the content delivery utility.

MA is an electronics distributor selling Sony™ 50 inch flat screen televisions. MA registers with the social network of the present invention and creates an original inventory data with name SONY50 (802) and the following information; two product images, a short description, a long description, suggested retail price, wholesale price, and five consumer reviews. Each of these pieces of information defines a data element encapsulated in the business data profile.

MB is an electronics retailer selling televisions online. MB registers with the social network of the present invention and discovers SONY50 and connects to MA. MA agrees to share its SONY50 inventory with MB (804) and grants MB access to SONY50, allowing MB to resell the Sony™ 50 inch flat screen televisions. MB decides that MA's long description is unsuitable for its marketing needs and creates a new inventory data, SONY51 (806) which is also for a Sony™ 50 inch flat screen television. MB publishes SONY51 on its e-commerce website. When a consumer buys a Sony™ 50 inch flat screen television by means of SONY51, the order acceptance utility determines whether or not MB has inventory of the Sony™ 50 inch flat screen television (808). If MB does have inventory, the Sony™ 50 inch flat screen television is ordered from MB and sent to the customer (810). If MB does not have inventory, then a Sony™ 50 inch flat screen television is ordered from MA and shipped to the customer (812). In this manner the present invention allows network members to pool their marketing and inventory management skills to the mutual benefit of all users. Business members can benefit from the experiences and resources of other members of the network to enhance their profitability. MA could learn from the experiences MB has had in selling from its SONY51 and potentially modify its own inventory data accordingly to increase sales.

It should be noted that the foregoing are merely examples of the kinds of applications that could be developed by the present invention to facilitate business transactions. The present invention contemplates the development of additional tools within the network, potentially by third parties, to allow for increased business data sharing and greater market access for all users. Such tools may include, but are not limited to, automated transaction financing and marketing coordination applications, logistics and tracking applications, consumer feedback and behaviour management applications, accounting applications, taxation applications, content delivery applications such as stores, blogs, other social networks, offline publication applications to create magazines, newspapers, flyers or content for those publications. They may also relate to non-business uses.

1. A computer implemented method of sharing data among a plurality of users, the method comprising:
(a) enabling a first user to create one or more data profiles, each data profile comprising one or more data elements;
(b) sharing one or more of the data profiles with a second user;
(c) enabling the second user to generate, or facilitate the generation of, by means of one or more computer processors, one or more additional data elements corresponding to a selected data profile; and
(d) enabling the first user to selectively modify the selected data profile by adding the additional data element to the selected data profile.

2. The method of claim 1, comprising the further step of enabling the first user to share the modified selected data profile with a third user if the first user applied the modification.

3. The method of claim 1, wherein the additional data element comprises a modification to a selected data element of the data profile.

4. The method of claim 3, wherein adding the additional data element augments the selected data profile with the additional data element.

5. The method of claim 1, wherein the additional data element comprises new data.

6. The method of claim 1, wherein at least one of the data profiles is an inventory profile.

7. The method of claim 6, wherein the inventory profile is associated with inventory owned by the first user, and wherein the inventory profile is shared with the second user for enabling the second user to sell the inventory owned by the first user.

8. The method of claim 7, wherein the second user generates one or more additional data elements, and wherein the second user publishes the inventory profile to a website.

9. The method of claim 7, wherein the second user publishes the inventory profile to a website, and wherein the second user enables one or more consumers to generate the additional data elements by means of the website.

10. The method of claim 7, wherein a sale of the inventory by the second user is communicated to the first user and the first user transfers the inventory to the one or more consumer.

11. The method of claim 1, comprising the further step of enabling the first user to establish security settings for defining which of the data elements are shared with the second user.

12. A system for sharing data among a plurality of users, the system comprising:
(a) a data profile database defined by one or more linked databases;
(b) a server computer linked to the data profile database, the server computer operable to:
(i) enable a first user to create one or more first data profiles for storing on the data profile database, each data profile comprising one or more data elements;
(ii) share the one or more first data profiles with a second user;
(iii) enable the second user to generate, or facilitate the generation of one or more additional data elements corresponding to a selected data profile; and
(iv) enable the first user to selectively modify the selected data profile by adding the additional data element to the selected data profile.

13. The system of claim 12, wherein the server computer is further operable to enable the first user to share the modified selected data profile with a third user if the first user applied the modification.

14. The system of claim 12, wherein the additional data element comprises a modification to a selected data element of the data profile.

15. The system of claim 14, wherein adding the additional data element augments the selected data profile with the additional data element.

16. The system of claim 12, wherein the additional data element comprises new data.

17. The system of claim 12, wherein at least one of the data profiles is an inventory profile.

18. The system of claim 17, wherein the inventory profile is associated with inventory owned by the first user, and wherein the inventory profile is shared with the second user for enabling the second user to sell the inventory owned by the first user.

19. The system of claim 17, wherein the server computer is further operable to:
enable the second user to publish the inventory profile to a website; and
enable one or more consumers to generate the additional data profile by means of the website.

20. A computer network implemented method of sharing data among a plurality of users in a social network, the method comprising:
(a) providing, or facilitating providing, by means of one or more computer processors, a social network having a plurality of users as members, one of the plurality of users being a prospective user and the remaining users being offering users;
(b) providing access to a plurality of data profiles to the prospective user by means of the social network, each data profile associated with an offering user, each data profile comprising one or more data elements;
(c) enabling the prospective user to select, by means of the social network, one or more of the data profiles;
(d) enabling the prospective user to publish at least one of the data profiles on a website;
(e) enabling the prospective user to generate, or facilitate the generation of, an additional data element corresponding to the published data profile; and
(f) enabling the offering user associated with the published user data to selectively modify the published data profile by adding the additional data element to the published data profile.
